(19) United States
(12) Patent Application Publication
(10) Pub. No.: US 2015/0079452 A1
(43) Pub. Date: Mar. 19, 2015

(54) BATTERY MODULE

(71) Applicant: SAMSUNG SDI CO., LTD., Yongin-si (KR)

(72) Inventors: Shi-Dong PARK, Yongin-si (KR); Jong-Han RHEE, Yongin-si (KR); Tae-Yong KIM, Yongin-si (KR); Jun-Woo CHO, Yongin-si (KR); Seong-Joon PARK, Yongin-si (KR)

(21) Appl. No.: 14/477,085

(22) Filed: Sep. 4, 2014

(30) Foreign Application Priority Data
Sep. 17, 2013 (KR) 10-2013-0111601

(51) Int. Cl. H01M 2/10

(52) U.S. Cl. CPC H01M 2/1077; H01M 2220/20
USPC 429/156

(57) ABSTRACT

A battery module includes a plurality of battery cells aligned in one direction, and a side plate disposed adjacent to side surfaces of the plurality of battery cells, the side plate including a compression area protruding toward the battery cells and configured to compress the battery cells.

### CROSS-REFERENCE TO RELATED APPLICATION

Korean Patent Application No. 10-2013-0111601, filed on Sep. 17, 2013, in the Korean Intellectual Property Office, and entitled: “Battery Module,” is incorporated by reference herein in its entirety.

### BACKGROUND

1. Field

Embodiments relate to a battery module.

2. Description of the Related Art

In general, battery cells are used as energy sources for mobile devices, electric vehicles, hybrid vehicles and the like. The shape of the battery cell is variously changed depending on the kind of external device to which the battery cell is applied.

A compact mobile device, e.g., a cellular phone, can be operated with the power and capacity of a single battery cell for a predetermined time. However, in a case where long-time driving and high-power driving are required in an electric vehicle or hybrid vehicle which consumes a large amount of power, a large-capacity battery module is configured by electrically connecting a plurality of battery cells in order to increase power and capacity. The output voltage or output current of the battery module may be increased according to the number of battery cells built in the battery module. In addition, a battery pack may be configured by electrically connecting such battery modules.

### SUMMARY

According to embodiments, there is provided a battery module including a plurality of battery cells aligned in one direction, and a side plate disposed adjacent to side surfaces of the plurality of battery cells, the side plate including a compression area protruding toward the battery cells and configured to compress the battery cells.

The compression area may be defined by a curvature of the side plate in the direction of the battery cells.

The compression area may be maintained in a plane shape after the side plate contacts the side surfaces of the battery cells.

The compression area may be configured to compress the battery cells by tension generated in the plane-shaped compression area.

The compression area may include first and second accommodating portions on one surface of the side plate, a compression member having first and second ends respectively accommodated in the first and second accommodating portions, the compression member having a curvature protruding in the direction of the battery cells, and a cut-away portion in the one surface of the side plate, the compression member protruding toward the battery cells through the cut-away portion.

The compression member may include a bending portion having a curved, and first and second guide portions respectively extended from both sides of the bending portion, the first and second guide portions being respectively accommodated in the first and second accommodating portions.

The side plate may contact the side surfaces of the battery cells, the first and second guide portions are further inserted into the respective first and second accommodating portions, so the bending portion is maintained in a plane shape.

The bending portion may be configured to compress the battery cell.

The battery module may further include two end plates adjacent to respective outermost battery cells among the plurality of battery cells, the side plate being connected to the two end plates to maintain the compression area of the side plate in the plane shape.

The side plate may include first and second side plates, each of the first and second side plates being coupled between the two end plates to define a volumetric space for the plurality of battery cells, and the first and second side plates being configured to contact the battery cells from opposite directions and to exert tension on the battery cells in opposite direction.

Upper and lower end portions of the side plate may be bent at least once or more.

The compression area may be a portion of the side plate that curves toward the battery cells.

The compression area may be a central portion of the side plate that curves toward and contacts the battery cells.

The compression area may be flattened upon contact with the battery cells.

### BRIEF DESCRIPTION OF THE DRAWINGS

Features will become apparent to those of ordinary skill in the art by describing in detail exemplary embodiments with reference to the attached drawings, in which:

FIG. 1 illustrates a perspective view of a battery module according to an embodiment.

FIG. 2 illustrates an exploded perspective view of the battery module of FIG. 1.

FIGS. 3A-3B illustrate schematic views of a side plate for compressing a battery cell according to an embodiment.

FIG. 4 illustrates a perspective view of a battery module including a side plate according to another embodiment.

FIG. 5 illustrates an exploded perspective view of the battery module of FIG. 4.

FIG. 6 illustrates a perspective, exploded view of a side plate with a compression member in FIG. 5.

FIG. 7 illustrates a perspective, assembled view of the side plate with the compression member in FIG. 6.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Like reference numerals refer to like elements throughout.

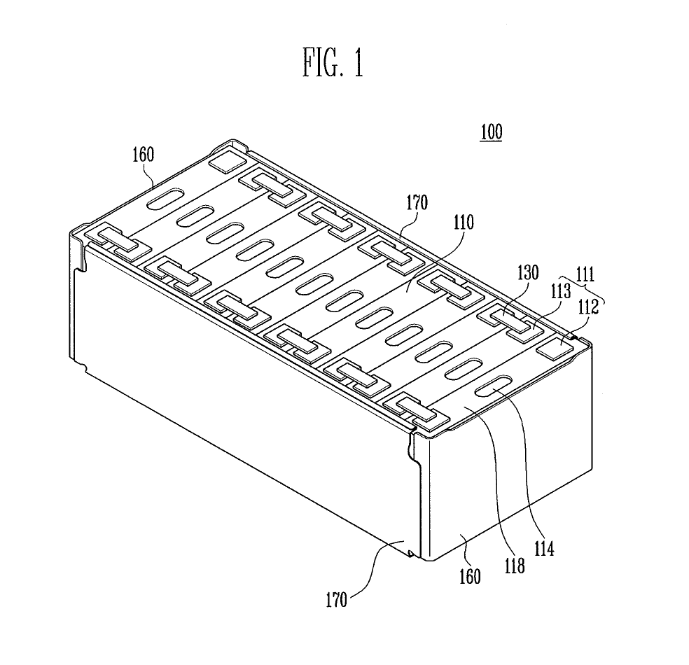

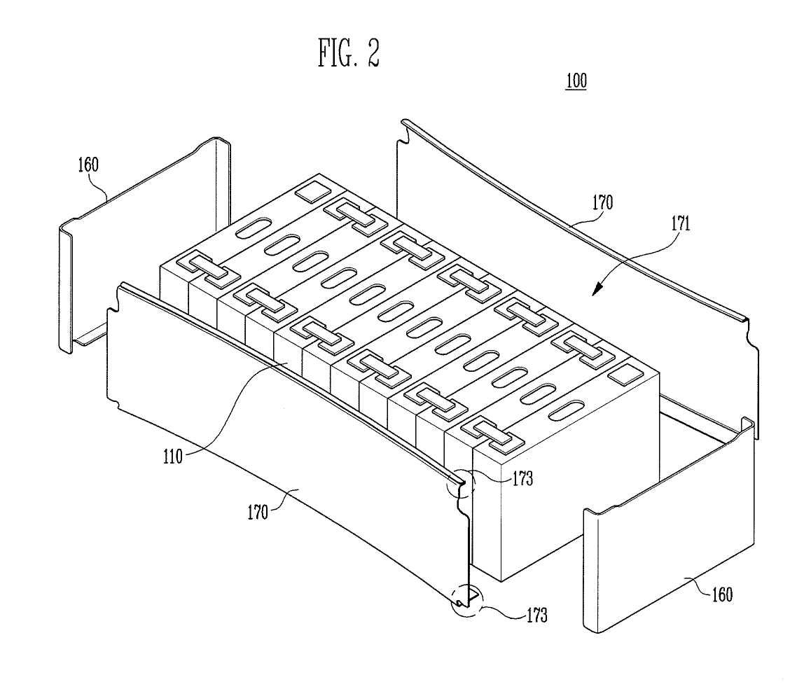

FIG. 1 illustrates a perspective view of a battery module according to an embodiment. FIG. 2 illustrates an exploded perspective view of the battery module of FIG. 1.

A battery module 100 according to an embodiment may include a plurality of battery cells 110 aligned in one direction. In this case, the battery cells 110 may be aligned so that wide surfaces of adjacent battery cells 110 face each other.

The battery cell 110 constituting the battery module 100 may include a battery case of which one surface is opened, and an electrode assembly and an electrolyte, which are accommodated in the battery case. The electrode assembly and the electrolyte generate energy through an electrochemical reaction therebetween. The battery case may be hermetically sealed by a first surface 118 of the battery cell 110. For example, the first surface 118 of the battery cell 110 may include a cap assembly. The first surface 118 may be provided with positive and negative electrode terminals 112 and 113 having different polarities, and a vent portion 114. Here, the positive and negative electrode terminals 112 and 113 are included in a terminal portion 111. The vent portion 114 is a safety means which acts as a passage through which gas generated inside the battery cell 110 is exhausted to the outside of the battery cell 110.

In the present embodiment, a case where the battery cell 110 is a prismatic lithium ion secondary battery will be described as an example. However, embodiments are not limited thereto, and may be applied to various types of batteries, e.g., a lithium polymer battery and the like.

A pair of end plates 160 may be respectively provided adjacent to outermost battery cells 110, and a pair of side plates 170 connecting between the pair of end plates 160 may be respectively disposed at side surfaces of the battery cell 110. In this case, the end plate 160 and the side plate 170 may be coupled to each other through laser welding or ultrasonic welding. The plurality of battery cells 110 may be aligned in one direction within a space defined by the pair of end plates 160 and the pair of side plates 170.

In this case, the battery cells 110 are aligned so that wide surfaces of the battery cells 110 face each other, and thus the positive and negative electrode terminals 112 and 113 of two adjacent battery cells 110 can be electrically connected through a bus-bar 130. The bus-bar 130 may be made of an electrical conductive metal, e.g., gold, silver, copper, nickel, aluminum, copper alloy or aluminum alloy, so that the positive and negative electrode terminals 112 and 113 of the two adjacent battery cells 110 can be electrically connected to each other. The bus-bar 130 may be bonded to the terminal portion 111 through welding. Here, the welding may be, e.g., laser welding or ultrasonic welding. It will be apparent that the shape of the bus-bar 130 may be variously formed according to the shape of the terminal portion 111.

According to an embodiment, the side plate 170 may overlap the aligned battery cells 110, e.g., the side plate 170 may overlap all the aligned battery cells 110. The side plate 170 may have a compression area 171 protruding in the direction of the battery cell 110 to compress the battery cell 110. In other words, the compression area 171 is a portion of the side plate 170 that curves toward the battery cells 110.

In detail, the compression area 171 is formed by a curvature applied to the side plate 170 in the direction of the battery cells 110. For example, an entire center portion of each of the two side plates 170 may protrude, e.g., curve, toward the battery cells 110. When the side plate 170 is adhered closely to the side surfaces of the battery cells 110, the compression area 171 is maintained in a plane shape, e.g., the curved portions of the side plates 170 press against the battery cells 110 to straighten into a substantially flat shape. For example, in order to maintain the compression area 171 in the plane shape, the side plates 170 may be coupled to the end plates 160 through laser welding or ultrasonic welding. In another example, although not shown in these figures, fastening holes may be provided in the end plates 160 and the side plates 170, so the end plates 160 and the side plates 170 may be fastened to each other by a screw or bolt inserted into the fastening holes.

As the compression area 171 protruding in the direction of the battery cell 110 is maintained in the plane shape, the generated tension, i.e., tension required to restore the flattened side plate 170 into its original curved shape, is stored in the flattened side plate 170, e.g., like operation of a spring. The stored tension in the side plate 170 is directed toward the battery cell 110, thereby allowing the side plate 170 to compress the battery cell 110. In addition, according to an embodiment, a bending portion 173 bent at least once or more may be formed at upper and lower end portions of the side plate 170 in order to further intensify the tension generated in the compression area 171.

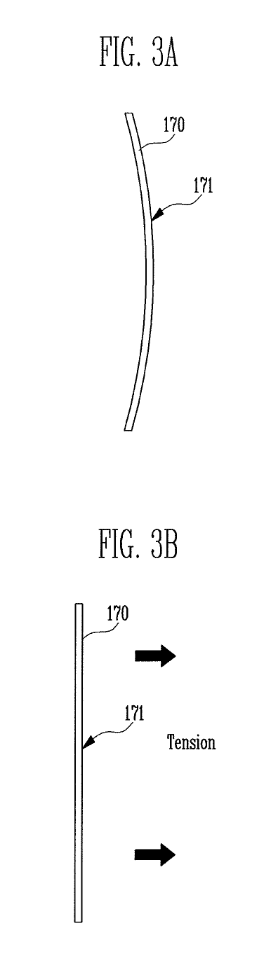

FIGS. 3A and 3B illustrate schematic views of an operation of the side plate 170 according to an embodiment.

Referring to FIG. 3A, the compression area 171 formed by the curvature of the side plate 170 may protrude in a predetermined direction. For example, in FIG. 3A, the compression area 171 curves to the right side of the figure. Referring to FIG. 3B, when the side plate 170 is straightened into a flat structure, i.e., maintained in a plane shape, tension is generated in the direction of the arrows, i.e., in a direction of a restoration force required to restore the side plate 170 of FIG. 3B into its original shape (FIG. 3A).

Therefore, according to embodiments, the side plate 170 compresses the battery cells 110 via the tension generated in the compression area 171. Thus, the side plate 170 can firmly fix the battery cells 110 so that the battery cells 110 are not moved by an external force even though the number of the battery cells 110 constituting the battery module 100 is increased.

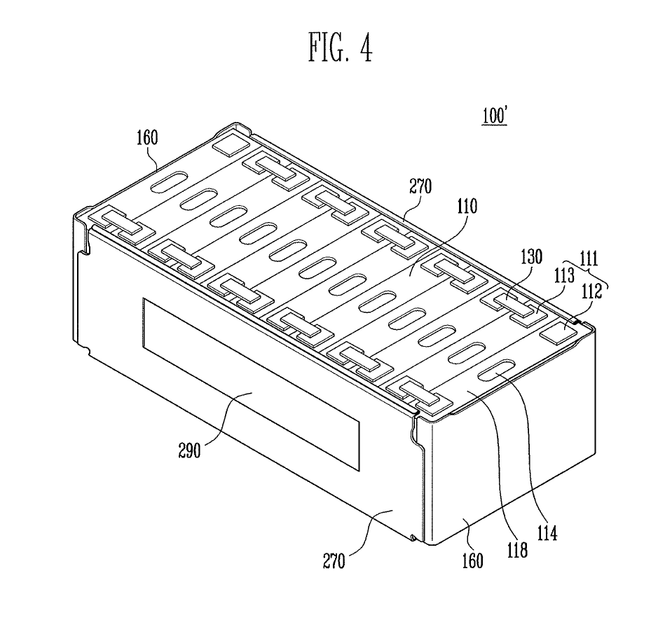

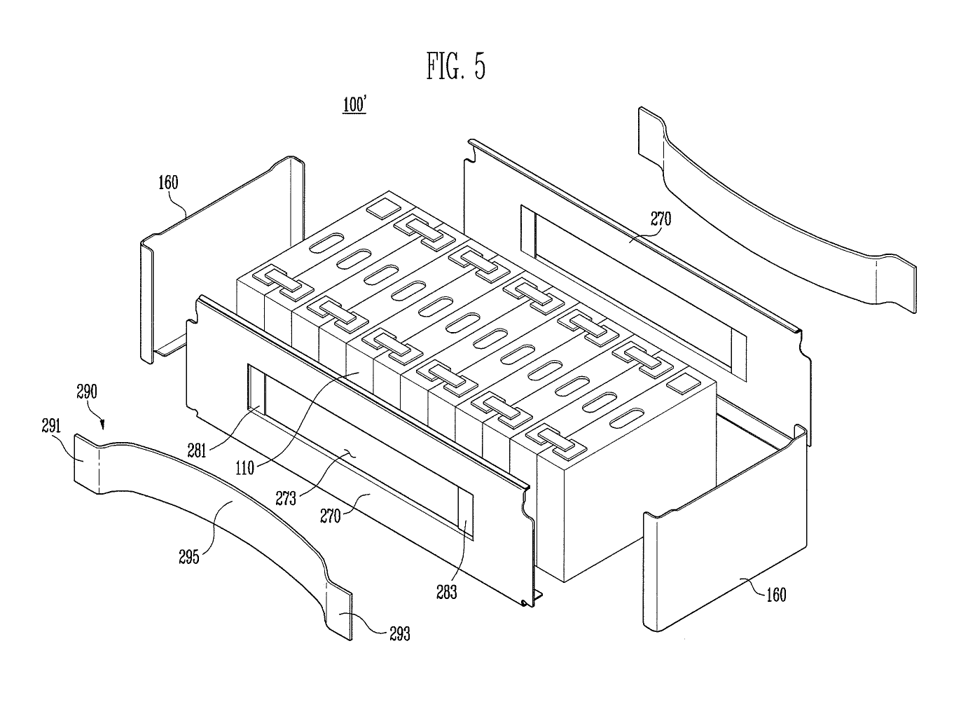

FIG. 4 illustrates a perspective view of a battery module including a side plate according to another embodiment. FIG. 5 illustrates an exploded perspective view of the battery module of FIG. 4. Hereinafter, the side plate of the battery module according to this embodiment will be described with reference to FIGS. 4 and 5. Here, components identical or corresponding to those of the aforementioned embodiment are designated by like reference numerals, and their detailed descriptions will be omitted to avoid redundancy.

Referring to FIGS. 4 and 5, a battery module 100′ according to another embodiment may be substantially the same as the battery module 100 in FIGS. 1-3, with the exception of including a side plate 270. The side plate 270 has a compression area protruding in the direction of the battery cells 110 to compress the battery cells 110.

As illustrated in FIG. 5, the compression area may include first and second accommodating portions 281 and 283 formed on one surface of the side plate 270, a compression member 290 having a curvature shape in the direction of the battery cell 110 and configured to have both ends respectively accommodated in the first and second accommodating portions 281 and 283, and a cut-away portion 273 formed in the one surface of the side plate 270 so that the compression member 290 passes therethrough. In other words, opposite ends of the compression member 290 are fitted into the accommodating portions 281 and 283 on an external surfaces of the side plate 270, so a central portion of the compression member 290 may fit through the cut-away portion 273 to contact the battery cells 110, e.g., the central portion of the compression member 290 may curve through an opening in the side plate 270 toward the battery cells 110.

When the side plate 270 is adhered closely to the side surfaces of the battery cells 110, the compression member 290 having the curvature shape is maintained in the plane shape. Accordingly, the compression member 290 compresses the battery cells 110 by the generated tension.

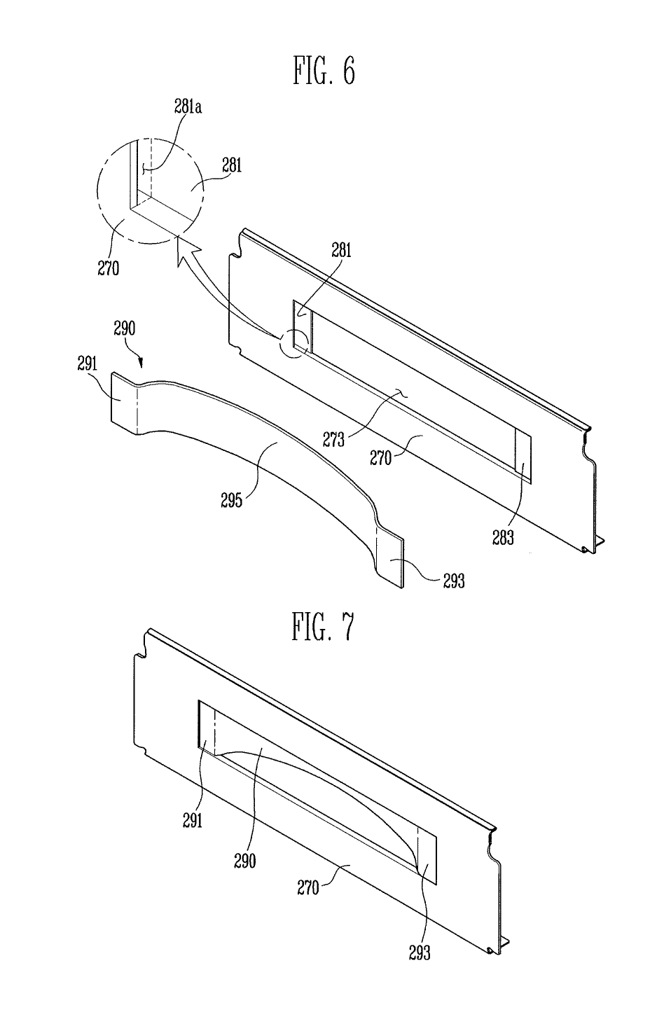

FIG. 6 illustrates a perspective, exploded view of the side plate 270 and the compression member 290. FIG. 7 illustrates a perspective, assembled view of the side plate 270 and the compression member 290.

Referring to FIGS. 6 and 7, the compression member 290 may include a bending portion 295 having a curvature shape, and first and second guide portions 291 and 293 respectively extended from both sides of the bending portion 295 to be accommodated in the first and second accommodating portions 281 and 283.

Before the side plate 270 is adhered closely to the side surface of the battery cell 110, only portions of the compression member 290 are inserted into the respective first and second accommodating portions 281 and 283. In a case where the side plate 270 is adhered closely to the side surface of the battery cell 110, the first and second guide portions 291 and 293 are further inserted into the respective first and second accommodating portions 281 and 283, so that the bending portion 295 can be maintained in the plane shape. In other words, when the side plate 270 is adhered closely to the side surfaces of the battery cells 110, the first and second guide portions 291 and 293 of the compression member 290 may slide further apart along the side plate to be inserted holes within the side plate 270, e.g., hole 281a in the first accommodating portion 281 (enlarged portion of FIG. 6).

A tension is generated in the direction of the battery cells 110 by the restoration force to be restored to the original shape, and the side plate 270 compresses the battery cells 110 by the tension. Therefore, the battery cells 110 cannot be moved by an external force.

By way of summary and review, the number of battery cells stacked in a battery module may be increased in order to increase the output voltage or output current of the battery module. However, as the number of battery cells is increased, the length of the battery module is lengthened. Accordingly, it may be difficult to ensure the numerical quality of the battery module, as the battery cells may be moved by an external force.

In contrast, exemplary embodiments provide a side plate of a battery module with a compression area protruding toward the battery cells. The compression area is a portion of the side plate that curves toward the battery cells and flattens upon contact with the battery cells. As such, tension generated in the flattened side plate, i.e., in the flattened compression area, is directed toward the battery cells, thereby supporting the battery cells. Accordingly, movement of the battery cells, e.g., due to an external force, may be prevented or substantially minimized, thereby improving the safety of the battery module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
a plurality of battery cells aligned in one direction; and
a side plate disposed adjacent to side surfaces of the plurality of battery cells, the side plate including a compression area protruding toward the battery cells and configured to compress the battery cells.

2. The battery module as claimed in claim 1, wherein the compression area is defined by a curvature of the side plate in the direction of the battery cells.

3. The battery module as claimed in claim 2, wherein the compression area is maintained in a plane shape after the side plate contacts the side surfaces of the battery cells.

4. The battery module as claimed in claim 3, wherein the compression area is configured to compress the battery cells by tension generated in the plane shaped compression area.

5. The battery module as claimed in claim 1, wherein the compression area includes:
first and second accommodating portions on one surface of the side plate;
a compression member having first and second ends respectively accommodated in the first and second accommodating portions, the compression member having a curvature protruding in the direction of the battery cells; and
a cut-away portion in the one surface of the side plate, the compression member protruding toward the battery cells through the cut-away portion.

6. The battery module as claimed in claim 5, wherein the compression member includes:
a bending portion having a curved; and
first and second guide portions respectively extended from both sides of the bending portion, the first and second guide portions being respectively accommodated in the first and second accommodating portions.

7. The battery module as claimed in claim 6, wherein, when the side plate contacts the side surfaces of the battery cells, the first and second guide portions are further inserted into the respective first and second accommodating portions, so the bending portion is maintained in a plane shape.

8. The battery module as claimed in claim 7, wherein the bending portion is configured to compress the battery cell.

9. The battery module as claimed in claim 1, further comprising two end plates adjacent to respective outermost battery cells among the plurality of battery cells, the side plate being connected to the two end plates to maintain the compression area of the side plate in a plane shape.

10. The battery module as claimed in claim 9, wherein the side plate includes first and second side plates, each of the first and second side plates being coupled between the two end plates to define a volumetric space for the plurality of battery cells, and the first and second side plates being configured to contact the battery cells from opposite directions and to exert tension on the battery cells in opposite direction.

11. The battery module as claimed in claim 1, wherein upper and lower end portions of the side plate are bent at least once or more.

12. The battery module as claimed in claim 1, wherein the compression area is a portion of the side plate that curves toward the battery cells.

13. The battery module as claimed in claim 12, wherein the compression area is a central portion of the side plate that curves toward and contacts the battery cells.

14. The battery module as claimed in claim 12, wherein the compression area is flattened upon contact with the battery cells.
